(19) United States
(12) Patent Application Publication
(10) Pub. No.: US 2005/0141361 A1
(43) Pub. Date: Jun. 30, 2005

(54) Apparatus for preventing damage of actuator coil in optical disc system and method for the same

(75) Inventors: Jae-kyung Oh, Suwon-si (KR); Jung-bum Suh, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/934,623

(22) Filed: Sep. 7, 2004

(30) Foreign Application Priority Data
Dec. 30, 2003 (KR) 2003-100639

(51) Int. Cl. G11B 7/00

(52) U.S. Cl. 369/44.25; 369/53.25; 369/44.29

(57) ABSTRACT

An apparatus to prevent damage of an actuator coil installed in a pickup and a method for the same. The method includes: generating a servo control signal from focus and tracking error signals generated from an optical pickup; detecting a peak value of the generated servo control signal; determining whether or not an oscillation status of the focus/tracking error signal by comparing the peak value of the servo control signal to a threshold value; and if it is determined that the servo control signal is in the oscillation status for a predetermined time, cutting off a servo operation for a predetermined time by generating a servo off command

### CROSS-REFERENCE TO RELATED APPLICATION

This application claims the priority of Korean Patent Application No. 2003-100639, filed on Dec. 30, 2003, in the Korean Intellectual Property Office, the disclosure of which is incorporated herein in its entirety by reference.

### BACKGROUND OF THE INVENTION

1. Field of the Invention

The present invention relates to an optical disc reproducing and recording system, and more particularly, to an apparatus to prevent damage of an actuator coil installed in a pickup and a method for the same.

2. Description of the Related Art

Commonly, an optical disc reproducing system reproduces information recorded on various optical discs such as compact discs (CDs), compact disc-read only memories (CD-ROMs), laser discs (LDs), mini discs (MDs), and digital video discs (DVDs). The optical disc reproducing system adapts various kinds of servo controls including a mechanical driving control to substantially exactly pick up RF signals from a disc. There are basically 4 servo controls: a spindle servo control, a focusing servo control, a tracking servo control, and a sled servo control.

In a servo control apparatus used in a conventional optical disc reproducing system, an optical pickup generates RF signals converted into electrical signals by optically picking up information recorded on a disc. In this case, the optical pickup includes a focusing actuator and a tracking actuator. The focusing actuator moves an object lens in an optical axis direction in response to a focusing control signal that is output from a focusing compensation filter. Meanwhile, the tracking actuator traces a track by moving the object lens in a radial direction of a disc in response to a tracking control signal that is output from a tracking compensation filter.

The servo control apparatus is designed so that oscillation is not substantially generated in focus or tracking servo control signals for a stable servo operation.

However, in a conventional optical disc reproducing system, a sensitivity deviation of a pickup is generated due to a reflexibility of a disc or to mechanical characteristics of an actuator. At this time, oscillation of servo control signals may be continuously generated due to the sensitivity deviation of the pickup. These continuous servo oscillation signals may destroy a focus or tracking actuator coil and an object lens connected to the coil by flowing an over current to the focusing or tracking actuator coil.

### SUMMARY OF THE INVENTION

The present invention provides a pickup damage preventing apparatus of an optical disc system, which prevents an actuator coil and an object lens from being destroyed by stopping a servo operation for a predetermined time when a servo error signal in an oscillation status is detected from a focus/tracking servo operation, and a method for the same.

According to an aspect of the present invention, there is provided a method of preventing damage of an actuator coil in an optical disc system, the method comprising: generating a servo control signal from focus and tracking error signals generated from an optical pickup; detecting a peak value of the generated servo control signal; determining whether an oscillation status of the focus/tracking error signal is in effect by comparing the detected peak value of the servo control signal with a threshold value; and if the servo control signal is determined to be in the oscillation status for a first predetermined time, cutting off a servo operation for a second predetermined time by generating a servo off command.

According to another aspect of the present invention, there is provided an apparatus to prevent damage of an actuator coil in an optical disc system. The apparatus comprises: an RF amplifier to extract focus and tracking error signals by amplifying an RF signal reflecting from a disc; a servo signal processing unit to generate a level/phase-compensated servo control signal from the focus and tracking error signals amplified by the RF amplifier and to turn a servo loop on/off in response to a servo on/off command; a peak value detector to detect a peak value of the servo control signal generated by the servo signal processing unit; a comparator to determine whether an oscillation status is in effect by comparing the peak value of the servo control signal detected by the peak value detector with a threshold value; and a microprocessor to output a servo off command to the servo signal processing unit if a logic signal corresponding to the oscillation status is input from the comparator for a predetermined time.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus for preventing damage of an actuator coil in an optical disc system according to an exemplary embodiment of the present invention;

FIG. 2 is a front view of a pickup of FIG. 1;

FIG. 3 is a graph showing a waveform of a correct servo control signal and a waveform of an oscillating servo control signal;

FIG. 4 is an equivalent circuit diagram of a peak value detector of FIG. 2; and

FIG. 5 is a flowchart of a method of preventing damage of an actuator coil in an optical disc system according to an exemplary embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

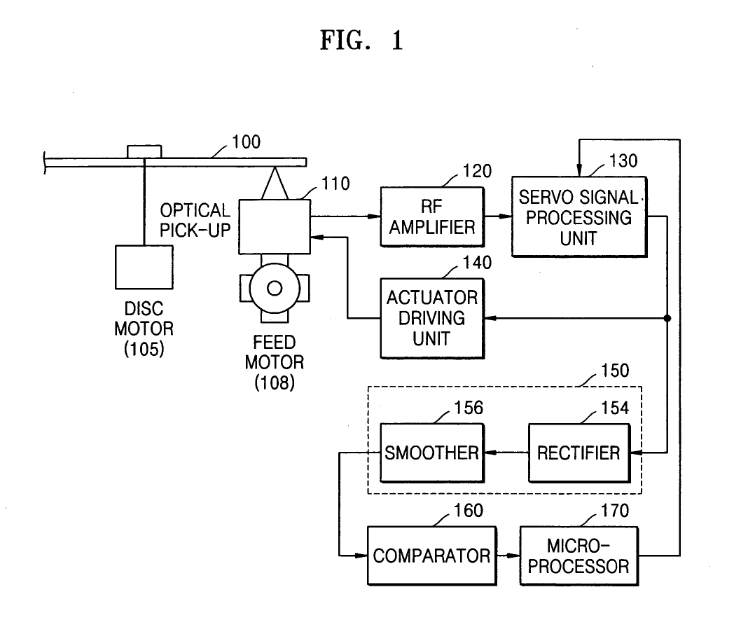

FIG. 1 is a block diagram of an apparatus to prevent damage of an actuator coil in an optical disc system according to an exemplary embodiment of the present invention.

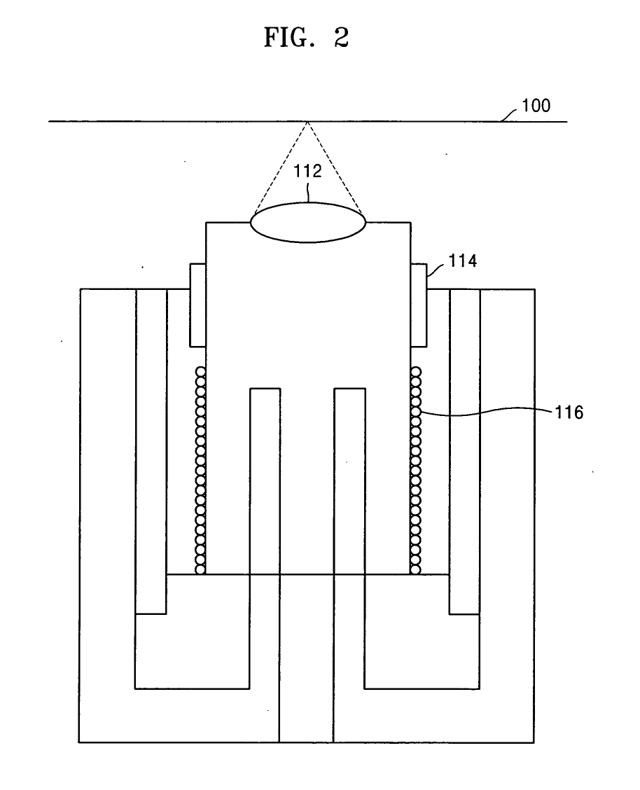

Referring to FIG. 1, an optical pickup 110 is driven by a tracking actuator (not shown) to control servo tracking and a focusing actuator (not shown) to control servo focusing. The optical pickup converts information that is recorded on a surface of a disc 100 into an electrical RF signal by optically picking up the information. Referring to an optical pickup structure shown in FIG. 2, an object lens 112 emits a laser beam that is condensed on a signal surface of the disc 100. A focusing actuator coil 116 drives the object lens 112 so that the signal surface of the disc 100 is placed within a focus depth of the laser beam. A tracking actuator coil 114 drives the object lens 112 so that a laser beam to be used in optical pickup may exactly trace along a track of the disc 100.

The RF amplifier 120 amplifies the RF signal output from the optical pickup 110. At this time, the RF amplifier 120 generates a focus error signal (FES) and a tracking error signal (TES) from the amplified RF signal by including a focus error detecting circuit (not shown) and a tracking error detecting circuit (not shown).

A servo signal processing unit 130 includes a focus servo control loop (not shown) and a tracking servo control loop (not shown) and generates a focus servo control signal, a tracking servo control signal, and a sled feed servo control signal from the FES and the TES generated by the RF amplifier 120 using gain/phase-compensated filtering. Also, the servo signal processing unit 130 cuts off the servo control signals in response to a servo on/off command output from a processor 170 for a predetermined time and then turns on the servo control signals.

An actuator driving unit 140 drives the focusing actuator and the tracking actuator in the pickup 110 using the focus servo control signal and the tracking servo control signal generated by the servo signal processing unit 130.

A disc motor 105 rotates the disc 100 with a constant linear velocity (CLV) method or a constant angular velocity (CAV) method using a disc driving signal output from a disc motor driving unit (not shown).

A feed motor 108 moves the optical pickup using the sled feed servo control signal generated by the servo signal processing unit 130.

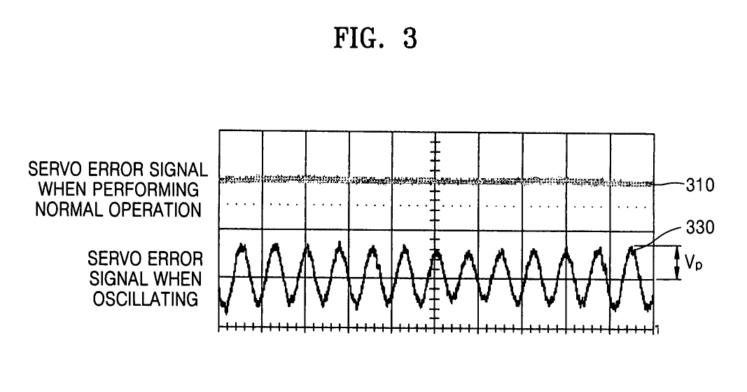

A peak value detector 150 detects a peak value of the focus/tracking servo control signal that is generated by the servo signal processing unit 130 when a servo error signal is oscillated due to a pickup sensitivity deviation. That is, as shown in FIG. 3, the servo signal processing unit 130 generates a relatively smooth servo control signal 310 when performing a normal servo operation and a continuously oscillating servo control signal 330 when performing an abnormal servo operation. Therefore, the peak value detector 150 detects a peak value of the oscillating servo control signal 330. In a normal servo error signal without oscillation, an error voltage Vₚ is maintained with a very low value except for a moment, and in an oscillating servo error signal, the error voltage Vₚ is continuously maintained with a very high value.

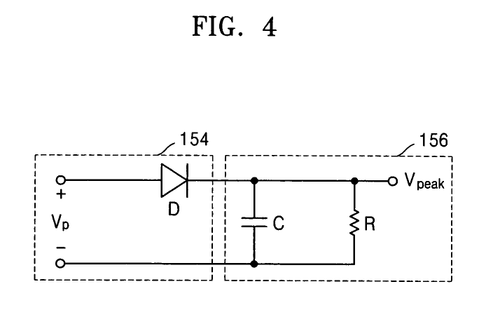

FIG. 4 is an example of the peak value detector 150, and the peak value detector 150 includes a rectifier 154 and a smoother 156. The rectifier 154 half wave rectifies a focusing/tracking servo control signal Vₚ with an oscillating pattern using a diode D. The smoother 156 holds the signal that is half wave rectified by the rectifier 154 using a capacitor C and a register R.

A comparator 160 determines an oscillation status is in effect by comparing the peak value Vₚₑₐₖ of the servo control signal detected by the peak value detector 150 to a threshold value Vₜₕ. That is, if the peak value Vₚₑₐₖ is larger than or equal to the threshold value Vₜₕ, the comparator 160 outputs a logic “high” signal indicating that the servo control signal is in the oscillation status, and otherwise, the comparator 160 outputs a logic “low” signal indicating that the servo control signal is in a normal status.

The microprocessor 170 outputs a servo on/off command and a phase compensation filter coefficient to the servo signal processing unit 130. The microprocessor 170 outputs a servo on command to the servo signal processing unit 130 when performing a normal servo operation, and if the microprocessor 170 receives a logic high signal from the comparator 160, the microprocessor 170 recognizes that the servo control signal is in the oscillation status and outputs a servo off command to the servo signal processing unit 130.

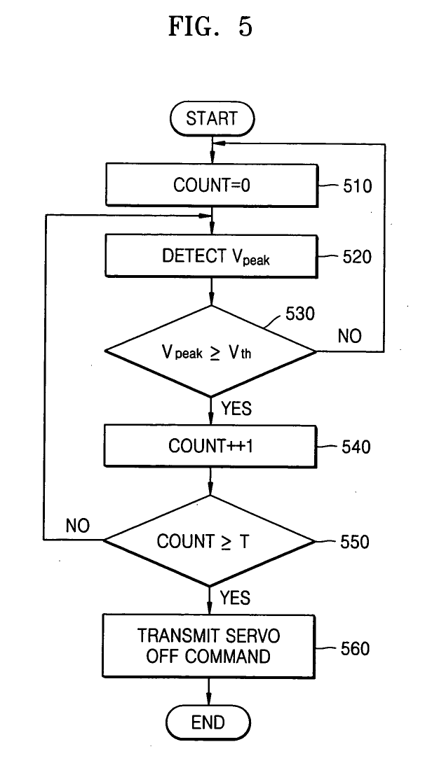

FIG. 5 is a flowchart of a method of preventing damage of an actuator coil in an optical disc system according to an exemplary embodiment of the present invention.

A count register, such as a timer that is coupled to the microprocessor 170, is initialized in operation 510 so as to begin counting a time lapse from the start of the method of preventing damage of an actuator coil in the optical disc system.

A peak value of a focus/tracking servo control signal is detected in operation 520.

The peak value Vₚₑₐₖ of the servo control signal is compared with a threshold value Vₜₕ in operation 530. At this time, if the peak value Vₚₑₐₖ of the servo control signal is smaller than the threshold value Vₜₕ, this process returns to operation 510, and whenever the peak value Vₚₑₐₖ of the servo control signal is larger than or equal to the threshold value Vₜₕ, a count value is increased by 1 in operation 540.

Whether the count value is a value T corresponding to the predetermined time is checked in operation 550. At this time, if the count value is the value T, a servo off command is generated in operation 560, and otherwise, this process returns to operation 520.

Eventually, if an oscillation status of a servo error signal is sensed for more than the predetermined time, by generating a servo off command, a continuous maintenance of the oscillation status is made possible. Also, the destruction of an actuator coil and an object lens connected to the actuator coil is prevented.

As is described above, according to the present invention, an actuator coil and an object lens installed in a pickup are prevented from being destroyed by stopping a servo operation for a predetermined time when an oscillation status is detected from a focus or tracking servo.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of preventing damage of an actuator coil in an optical disc system, the method comprising:
generating a servo control signal from focus and tracking error signals generated from an optical pickup;
detecting a peak value of the generated servo control signal;
determining whether an oscillation status of the servo control signal is in effect by comparing the detected peak value of the servo control signal with a threshold value; and
if the servo control signal is determined to be in the oscillation status for a first predetermined time, cutting off a servo operation for a second predetermined time by generating a servo off command.

2. The method of claim 1, wherein the detecting comprises detecting the peak value by rectifying and smoothing the servo control signal.

3. The method of claim 1, wherein the determining comprises:
if the peak value of the servo control signal is larger than or equal to the threshold value, determining that the servo control signal is in the oscillation status; and
if the peak value of the servo control signal is smaller than the threshold value, determining that the servo control signal is in a normal servo loop operation.

4. The method of claim 1, wherein the cutting off comprises turning a servo loop off for a predetermined time by transmitting a servo off command and then transmitting a servo on command.

5. An apparatus to prevent damage of an actuator coil in an optical disc system, the apparatus comprising:
an RF amplifier to extract focus and tracking error signals by amplifying an RF signal reflecting from a disc;
a servo signal processing unit to generate a level/phase-compensated servo control signal from the focus and tracking error signals amplified by the RF amplifier and to turn a servo loop on/off in response to a servo on/off command;
a peak value detector to detect a peak value of the servo control signal;
a comparator to determine whether an oscillation status is in effect by comparing the peak value of the servo control signal with a threshold value; and
a microprocessor to output a servo off command to the servo signal processing unit, if a logic signal corresponding to the oscillation status is input from the comparator for a predetermined time.

6. The apparatus of claim 5, wherein the peak value detector comprises:
a rectifier to rectify an oscillating focusing/tracking servo control signal; and
a smoother to hold a peak value of the signal rectified by the rectifier.

7. A method of preventing damage of an actuator coil in an optical disc system in which a servo control signal has been generated from focus and tracking error signals, the method comprising:
detecting a peak value of the generated servo control signal;
determining whether an oscillation status of the servo control signal is in effect; and
cutting off a servo operation if the servo control signal is determined to be in the oscillation status for a predetermined time.

8. The method according to claim 7, wherein the determining comprises comparing the peak value of the detected servo control signal with a threshold value.

9. The method according to claim 7, wherein the cutting off comprises generating a servo off command.

10. A method of preventing damage of an actuator coil in an optical disc system, the method comprising:
generating a servo control signal from focus and tracking error signals;
detecting a peak value of the generated servo control signal;
determining whether an oscillation status of the servo control signal is in effect; and
cutting off a servo operation if the servo control signal is determined to be in the oscillation status for a predetermined time.

11. The method according to claim 10, wherein the determining comprises comparing the peak value of the detected servo control signal with a threshold value.

12. The method according to claim 10, wherein the cutting off comprises generating a servo off command.

13. The method according to claim 10, wherein the generating comprises:
driving an optical pickup over a surface a disc containing information to optically pickup the information;
converting the information into an RF signal;
amplifying the RF signal; and
generating a focus error signal (FES) and a tracking error signal (TES) from the amplified RF signal.

14. The method according to claim 13, wherein the driving comprises a combination of controlling servo tracking via a tracking actuator, controlling servo focusing via a focusing actuator, emitting a laser beam to be condensed onto the surface of the disc, and tracing the laser beam along a track of the disc.

15. The method according to claim 13, further comprising generating a focus servo control signal, a tracking servo control signal, and a sled feed servo control signal from the generated focus error signal FES and the generated tracking error signal TES.

16. The method according to claim 10, wherein the detecting comprises detecting the peak value of the generated servo control signal when a servo error signal is oscillated due to a pickup sensitivity deviation.

17. The method according to claim 16, wherein the detecting comprises:
recognizing a relatively smooth servo control signal, in which an error voltage Vₚ is maintained with a first value, when a normal servo operation is performed; and
recognizing a continuously oscillating servo control signal, in which the error voltage Vₚ is maintained with a second value that is different from the first value, when an abnormal servo operation is performed.

18. The method according to claim 17, wherein the detecting further comprises half wave rectifying a focusing/tracking servo control signal, which represents the error voltage Vₚ.

19. The method according to claim 18, wherein the detecting further comprises holding the half wave rectified signal using a capacitor and a register.

20. The method according to claim 10, further comprising providing a threshold value of a servo control signal, wherein the determining comprises comparing the detected peak value of the generated servo control signal to the threshold value.

21. The method according to claim 20, wherein the determining further comprises outputting a first logic signal to indicate that the servo control signal is in the oscillation status, if the detected peak value of the generated servo control signal is larger than or equal to the threshold value.

22. The method according to claim 21, wherein the determining further comprises outputting a second logic signal that is different from the first logic signal to indicate that the servo control signal is in a normal status, if the detected peak value of the generated servo control signal is lower than the threshold value.

23. The method according to claim 10, wherein the cutting off comprises:
outputting a servo on command when the oscillation status is not in effect; and
outputting a servo off command when the oscillation status is in effect.

24. A method of preventing damage of an actuator coil in an optical disc system, in which a threshold value of a servo control signal and a predetermined time limit during which the optical disc system is in an oscillation status are provided, the method comprising:
initializing a count register;
detecting a peak value of a focus/tracking servo control signal;
comparing the peak value of the focus/tracking servo control signal with the provided threshold value;
if the peak value of the focus/tracking servo control signal is smaller than the provided threshold value, returning to the initializing operation;
if the peak value of the focus/tracking servo control signal is equal to or larger than the provided threshold value, increasing a count value;
checking whether the count value corresponds with the predetermined time;
if the count value is less than the predetermined time, returning to the detecting operation; and
if the count value is equal to the predetermined time, generating a servo off command.

25. A method of preventing damage of an actuator coil in an optical disc system, in which a threshold value of a servo control signal and a predetermined time limit during which the optical disc system is in an oscillation status are provided, the method comprising:
initializing a count register;
detecting a peak value of a focus/tracking servo control signal;
comparing the peak value of the focus/tracking servo control signal with the provided threshold value;
if the peak value of the focus/tracking servo control signal is smaller than the provided threshold value, returning to the initializing operation;
if the peak value of the focus/tracking servo control signal is equal to or larger than the provided threshold value, increasing a count value;
checking whether the count value corresponds with the predetermined time;
if the count value is less than the predetermined time, returning to the detecting operation; and
if the count value is equal to the predetermined time, generating a servo off command, wherein the servo off command prevents damage to the optical disc system.

26. An apparatus to prevent damage of an actuator coil in an optical disc system, the apparatus comprising:
an RF amplifier to extract error signals by amplifying an RF signal reflecting from an disc;
a servo signal processing unit to generate a servo control signal from the error signals and to turn a servo loop on/off in response to a servo on/off command;
a peak value detector to detect a peak value of the servo control signal;
a comparator to determine whether an oscillation status is in effect by comparing the peak value of the servo control signal detected by the peak value detector with a threshold value; and
a microprocessor to output the servo off command to the servo signal processing unit, if a logic signal corresponding to the oscillation status is input from the comparator for a predetermined time, so as to cause the servo signal processing unit to turn the servo loop off.

27. The apparatus of claim 26, wherein the peak value detector comprises:
a rectifier to rectify the servo control signal; and
a smoother to hold a peak value of the rectified servo control signal.
